(19) United States
(12) Patent Application Publication
(10) Pub. No.: US 2004/0011393 A1
(43) Pub. Date: Jan. 22, 2004

(54) Crutch

(76) Inventor: Ted Whitworth, Rockwall, TX (US)

Correspondence Address: KONNEKER SMITH, 660 NORTH CENTRAL EXPRESSWAY, SUITE 230, PLANO, TX, 75074

(21) Appl. No.: 10/198,450

(22) Filed: Jul. 18, 2002

(51) Int. Cl. A61H 3/02

(52) U.S. Cl. 135/69; 135/68

(57) ABSTRACT

A crutch provides ease of adjustment, transport and storage. In a described embodiment, the crutch includes two length adjustment mechanisms. Each of the mechanisms includes an inner tube slidingly received within an outer tube, and a spring-biased protrusion carried on the inner tube and inserted into one of a series of holes formed through the outer tube, thereby securing the inner tube relative to the outer tube. An armpit support is attached to one of the inner tubes, a foot is attached to the other inner tube, and a handle is attached to one of the outer tubes.

### BACKGROUND

The present invention relates generally to advancements in the art of crutch design and, in an embodiment described herein, more particularly provides an improved crutch.

It is well known that conventional crutches are rather ungainly to transport and store. For example, a person entering a confined space, such as a car, with a crutch usually has difficulty passing the crutch into the interior of the car and finding a place to store the crutch in the car during a trip. As another example, a person taking an airplane flight usually has difficulty storing the crutch on the airplane.

Another problem with a conventional crutch is that it is difficult to adjust to suit a particular person's height and to provide maximum comfort while using the crutch. Separate adjustment mechanisms are typically provided for adjusting an overall length of the crutch, and for adjusting a distance between an armpit support and a handle of the crutch. At least one of these adjustment mechanisms is usually difficult to manipulate and/or requires two hands to operate.

From the foregoing, it can be seen that it would be quite desirable to provide a crutch which is convenient to transport and store and/or is convenient to adjust to suit a particular user. It is accordingly an object of the present invention to provide such a crutch.

### SUMMARY

In carrying out the principles of the present invention, in accordance with an embodiment thereof, a crutch is provided which solves the above problems in the art. The crutch is convenient to adjust, transport and store.

In one aspect of the invention, a crutch is provided which includes an armpit support, a handle and first and second length adjustment mechanisms. The first mechanism is operable to adjust both an overall length of the crutch and a distance between the armpit support and the handle. The second mechanism is operable to adjust the overall length of the crutch.

In another aspect of the invention, a crutch is provided which includes first and second length adjustment mechanisms, each of the mechanisms including an inner tube slidingly received within an outer tube, and a spring-biased protrusion carried on the inner tube and inserted into one of a series of holes formed through the outer tube, thereby securing the inner tube relative to the outer tube. An armpit support is attached to the first mechanism inner tube. A foot is attached to the second mechanism inner tube. A handle is attached to one of the first and second mechanism outer tubes.

Preferably, the first and second length adjustment mechanisms are parallel to each other.

These and other features, advantages, benefits and objects of the present invention will become apparent to one of ordinary skill in the art upon careful consideration of the detailed description of a representative embodiment of the invention hereinbelow and the accompanying drawings.

### BRIEF DESCRIPTION OF THE DRAWINGS

FIG. 1 (Prior Art) is an elevational view of a first prior art crutch;

FIG. 2 (Prior Art) is an elevational view of a second prior art crutch;

FIG. 3 is an elevational view of a crutch embodying principles of the present invention, the crutch being shown in a compressed configuration thereof; and

FIG. 4 is an elevational view of the crutch of FIG. 3, the crutch being shown in a fully extended configuration thereof.

### DETAILED DESCRIPTION

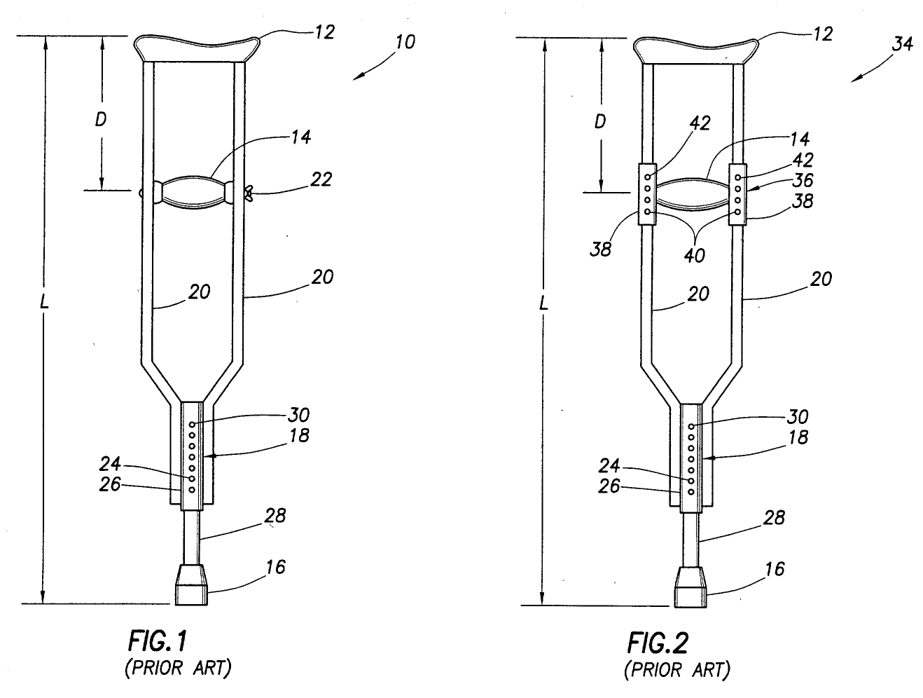

Illustrated in FIG. 1 is a prior art crutch 10. The crutch 10 includes an armpit support 12, a handle 14, a foot 16, a length adjustment mechanism 18 and elongated members 20 interconnecting the armpit support, handle and length adjustment mechanism.

A distance D between the armpit support 12 and the handle 14 may be adjusted by loosening a fastener 22 extending laterally through the handle and the members 20, removing the fastener, displacing the handle upward or downward to one of a series of holes formed through each of the members, replacing the fastener through the handle and the holes in the members, and tightening the fastener. This is a tedious process, requiring two hands to manipulate the handle 14 and fastener 22, and thus leaving no hands available to support the crutch 10 itself.

As a result, a user may not go to the trouble of making the adjustment him/herself. If a trained professional, such as a nurse, does not make the adjustment for the user, it is quite likely that the adjustment will not be made at all. In that case, the user will have to suffer through use of an ill-fitting crutch 10.

To adjust the overall length L of the crutch 10 from the armpit support 12 to the foot 16, the length adjustment mechanism 18 is used. The mechanism 18 includes a series of vertically aligned holes 24 formed through an outer tube 26, and an inner tube 28 telescopingly received in the inner tube. A spring-biased pin or other protrusion 30 carried on the inner tube 28 is inserted through one of the holes 24 to secure the inner tube relative to the outer tube 26 and fix the axial length of the mechanism 18.

Note that the length L of the crutch 10 may be shortened somewhat by adjusting the mechanism 18. However, the shortest length adjustment still leaves the length L quite long, making the crutch 10 difficult to transport in a car or other confined space, and prevents the crutch from being stored conveniently in an overhead bin of an aircraft.

Referring additionally now to FIG. 2, another prior art crutch 34 is illustrated. The crutch 34 is very similar to the crutch 10 described above, so elements of the crutch 34 illustrated in FIG. 2 are designated with the same reference numbers as similar elements of the crutch 10 illustrated in FIG. 1.

The crutch 34 differs from the crutch 10 in that a different mechanism 36 is used to adjust the distance D between the armpit support 12 and the handle 14. The mechanism 36 is similar to the mechanism 18. The members 20 are each slidingly received in an outer tube 38 attached at either end of the handle 14.

Each of the outer tubes 38 has a series of vertically aligned holes 40 formed therethrough. A spring-biased pin or other protrusion 42 is carried on each of the members 20. Each of the pins 42 is inserted into one of the holes 40 in each of the outer tubes 38 to fix the position of the handle 14 relative to the members 20.

It will be readily appreciated that use of the adjustment mechanism 36 having parallel outer tubes 38 and two pins 42 for insertion in each of two series of holes 40 is somewhat difficult. For example, two hands are required to depress the pins 42 and displace the handle 14 upward or downward on the members 20. This leaves no hands available to support the crutch 34 during the adjustment process.

Furthermore, as with the crutch 10 described above, the length L of the crutch 34 may be shortened somewhat by adjusting the mechanism 18. However, the shortest length adjustment still leaves the length L quite long, making the crutch 34 difficult to transport in a car or other confined space, and prevents the crutch from being stored conveniently in an overhead bin of an aircraft.

Representatively illustrated in FIG. 1 is a crutch 50 which embodies principles of the present invention. The crutch 50 provides convenient adjustment of both an overall length L and a distance D between an armpit support 52 and a handle 54. In addition, the overall length L may be easily shortened, so that the crutch 50 is conveniently transportable in a car or other confined space, and the crutch may be stored in an overhead bin of an aircraft.

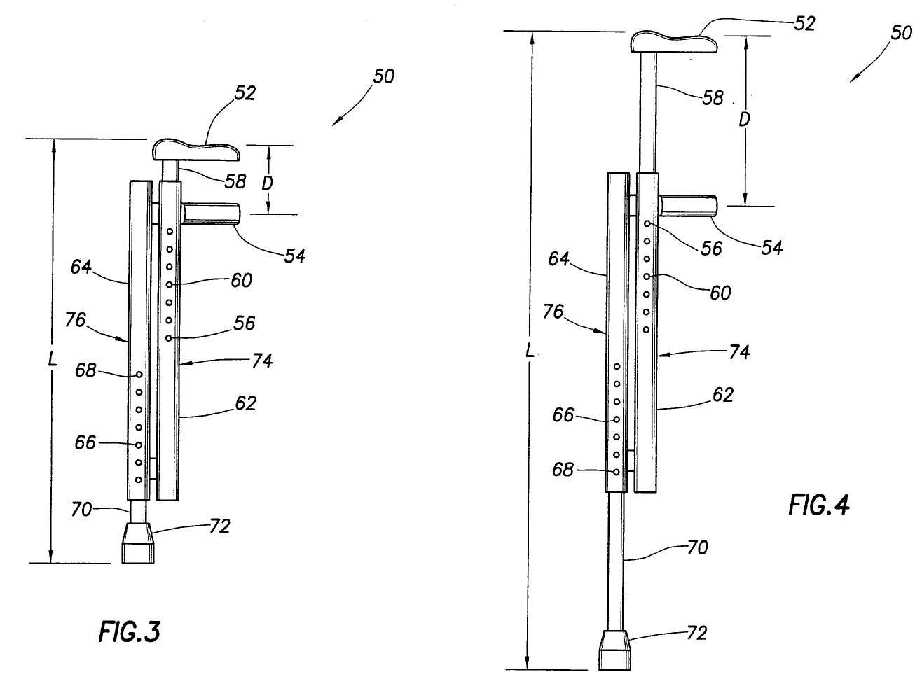

As depicted in FIG. 3, the crutch 50 is in its fully collapsed configuration. This configuration is achieved by depressing a spring-biased pin or other protrusion 56 carried on an inner tube 58 attached to the armpit support 52, and then inserting it into the lowest of a series of vertically aligned holes 60 formed through an outer tube 62. The outer tube 62 is also attached to the handle 54, and so this also shortens the distance D between the armpit support 52 and the handle 54.

Another outer tube 64 is attached to the outer tube 62. Preferably, the outer tubes 62, 64 are parallel to each other. The outer tube 64 has a series of vertically aligned holes 66 formed therethrough. A spring-biased pin or other protrusion 68 carried on an inner tube 70 attached to a foot 72 is inserted into an uppermost one of the holes 66 to make the length L its shortest.

In FIG. 4 the crutch 50 is depicted in its fully extended configuration. Note that the distance D Between the armpit support 52 and the handle 54 has been lengthened by depressing the pin 56 and inserting it into the uppermost one of the holes 60. This step also lengthens the overall length L. To further increase the length L, the pin 68 has been depressed and inserted into the lowermost one of the holes 66. Of course, the distance D and the length L may each be adjusted as desired between that shown in the FIGS. 3 & 4 by selecting appropriate ones of the holes 60, 66 in which to insert the respective pins 56, 68.

It may now be fully appreciated how the crutch 50 achieves its purposes of providing convenient adjustment, transport and storage. Only two hands are required to adjust each of the parallel telescoping tube mechanisms 74, 76, with one hand being used to support the crutch 50. Thus, the crutch 50 is far more convenient to adjust as compared to the prior art crutches 10, 34.

The crutch 50 may also be adjusted to a much shorter overall length L. This is due in part to the fact that adjustment of the distance D between the armpit support 52 and the handle 54 using the mechanism 74 also adjusts the overall length L, since the mechanisms 74, 76 are parallel to each other. The shorter overall length L makes the crutch 50 more convenient to transport in confined spaces, such as cars, and enables the crutch to be stored in an overhead bin of an aircraft.

Of course, a person skilled in the art would, upon a careful consideration of the above description of a representative embodiment of the invention, readily appreciate that many modifications, additions, substitutions, deletions, and other changes may be made to this specific embodiment, and such changes are contemplated by the principles of the present invention. Accordingly, the foregoing detailed description is to be clearly understood as being given by way of illustration and example only, the spirit and scope of the present invention being limited solely by the appended claims and their equivalents.

What is claimed is:

1. A crutch, comprising:
an armpit support;
a handle; and
first and second length adjustment mechanisms, the first mechanism being operable to adjust both an overall length of the crutch and a distance between the armpit support and the handle, and the second mechanism being operable to adjust the overall length of the crutch.

2. The crutch according to claim 1, wherein each of the first and second mechanisms includes inner and outer telescoping tubes, the first mechanism inner tube being attached to the armpit support, and the second mechanism inner tube being attached to a foot of the crutch.

3. The crutch according to claim 2, wherein the outer tubes of the first and second mechanisms are attached to each other.

4. The crutch according to claim 3, wherein the outer tubes are parallel to each other.

5. The crutch according to claim 4, wherein the handle is attached to at least one of the first and second mechanism outer tubes.

6. The crutch according to claim 1, wherein the first and second mechanisms are aligned parallel to each other.

7. The crutch according to claim 1, wherein the second mechanism is attached to a foot of the crutch.

8. A crutch, comprising:
first and second length adjustment mechanisms, each of the mechanisms including an inner tube slidingly received within an outer tube, and a spring-biased protrusion carried on the inner tube and inserted into one of a series of holes formed through the outer tube, thereby securing the inner tube relative to the outer tube;
an armpit support attached to the first mechanism inner tube;
a foot attached to the second mechanism inner tube; and
a handle attached to one of the first and second mechanism outer tubes.

9. The crutch according to claim 8, wherein the first mechanism outer tube is attached to the second mechanism outer tube.

10. The crutch according to claim 9, wherein the outer tubes are attached parallel to each other.

11. The crutch according to claim 8, wherein displacement of the first mechanism inner tube relative to the first mechanism outer tube adjusts a distance between the armpit support and the handle, and adjusts an overall length of the crutch.

12. The crutch according to claim 11, wherein displacement of the second mechanism inner tube relative to the second mechanism outer tube adjusts the overall length of the crutch.
